(19) United States
(12) Patent Application Publication
(10) Pub. No.: US 2026/0194941 A1
(43) Pub. Date: Jul. 9, 2026

(54) MULTIPLEXING MAINFRAME BUS BAR

(71) Applicant: INTERNATIONAL BUSINESS MACHINES CORPORATION, ARMONK, NY (US)

(72) Inventors: Joseph Scaglione, Poughkeepsie, NY (US); David Wolpert, Poughkeepsie, NY (US); Keenan Jefson Leggieri, Poughkeepsie, NY (US); Daniel Ruiz, Cold Spring, NY (US); Christopher John Petrucelli, Hyde Park, NY (US); Vinamra Vijay Agrawal, Poughkeepsie, NY (US)

(21) Appl. No.: 19/012,328

(22) Filed: Jan. 7, 2025

(51) Int. Cl. G06F 1/18; G06F 13/40

(52) U.S. Cl. CPC G06F 1/189; G06F 13/409

(57) ABSTRACT

An apparatus and a method of forming the apparatus, and a method of using the apparatus. The apparatus incudes: multiple mainframes; and a bus bar spanning across the multiple mainframes and connected to one or more ports on each mainframe, wherein any mainframe of the multiple mainframes is configured to be connected to any other mainframe of the multiple mainframes via the bus bar. Using the apparatus includes: routing a signal of a first type from a first port of a first mainframe of the multiple mainframes to a bus bar, through the bus bar along a length of the bus bar, and from the bus bar to a second port of a second mainframe of the multiple mainframes, wherein the bus bar spans across the first mainframe and the second mainframe and is connected to the first port and the second port.

### BACKGROUND

The present invention relates to mainframes, and more specifically, to connecting mainframes via a bus bar.

### SUMMARY

Embodiments of the present invention provide an apparatus, comprising: multiple mainframes; and a bus bar spanning across the multiple mainframes and connected to one or more ports on each mainframe, wherein any mainframe of the multiple mainframes is configured to be connected to any other mainframe of the multiple mainframes via the bus bar.

Embodiments of the present invention provide a method for using an apparatus, said method comprising: routing a signal of a first type from a first port of a first mainframe to a bus bar, through the bus bar along a length of the bus bar, and from the bus bar to a second port of a second mainframe, wherein the bus bar spans across the first mainframe and the second mainframe and is connected to the first port and the second port.

Embodiments of the present invention provide a method for forming an apparatus, said method comprising: spanning a bus bar across multiple mainframes; and connecting the bus bar to one or more ports on each mainframe of the multiple mainframes, wherein any mainframe of the multiple mainframes is configured to be connected to any other mainframe of the multiple mainframes via the bus bar.

### BRIEF DESCRIPTION OF THE DRAWINGS

FIG. 1 depicts an apparatus comprising multiple mainframes, a bus bar, and a mux-demux, in accordance with embodiments of the present invention.

FIG. 2 depicts alternative positioning of mainframes and a bus bar in an apparatus, in accordance with embodiments of the present invention.

FIG. 3 depicts the apparatus of FIG. 1 in greater detail, in accordance with embodiments of the present invention.

FIG. 4 depicts a modification of the apparatus of FIG. 3, in accordance with embodiments of the present invention.

FIG. 5 depicts the apparatus of FIG. 1 after the hardware in mainframes have been replaced by an emulation module, in accordance with embodiments of the present invention.

FIG. 6 is a flow chart describing a method for using an apparatus, in accordance with embodiments of the present invention.

FIG. 7 is a flow chart describing a process relating to implementation of a step of FIG. 6 which routes a signal from a first port of a first mainframe to a second port of a second mainframe, in accordance with embodiments of the present invention.

FIG. 8 is a flow chart for describing a method for forming an apparatus that includes multiple mainframes and a bus bar, in accordance with embodiments of the present invention

FIG. 9 illustrates a computer system, in accordance with embodiments of the present invention.

FIG. 10 depicts a computing environment which contains an example of an environment for the execution of at least some of the computer code involved in performing the inventive methods, in accordance with embodiments of the present invention.

### DETAILED DESCRIPTION

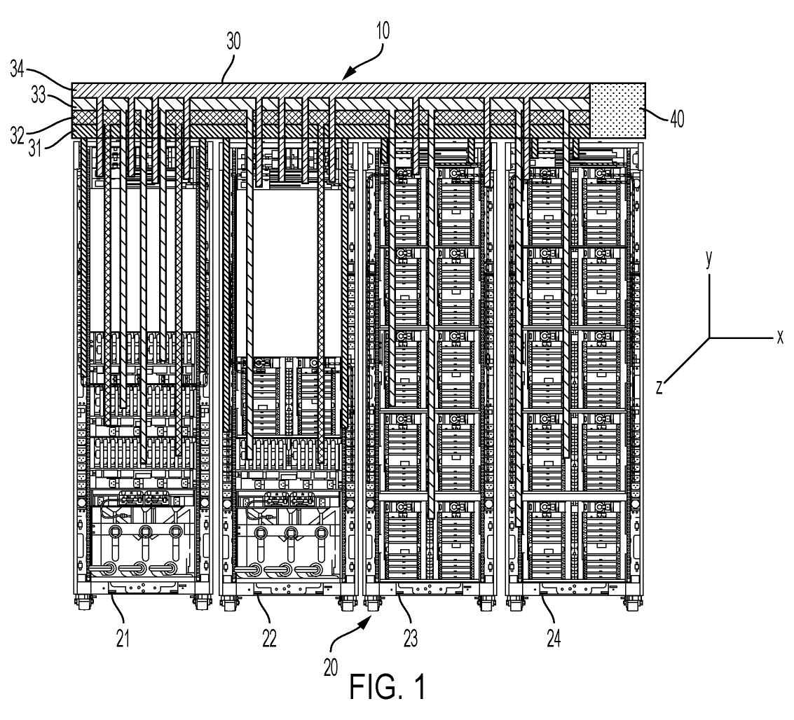

FIG. 1 depicts an apparatus 10 comprising multiple mainframes 20, a bus bar 30, and a mux-demux 40, in accordance with embodiments of the present invention. A mainframe is a high performance computer designed for efficient and secure processing of large amounts of data. The multiple mainframes 20 are organized within one or more racks that exist within a single mainframe system or are distributed across multiple mainframe systems.

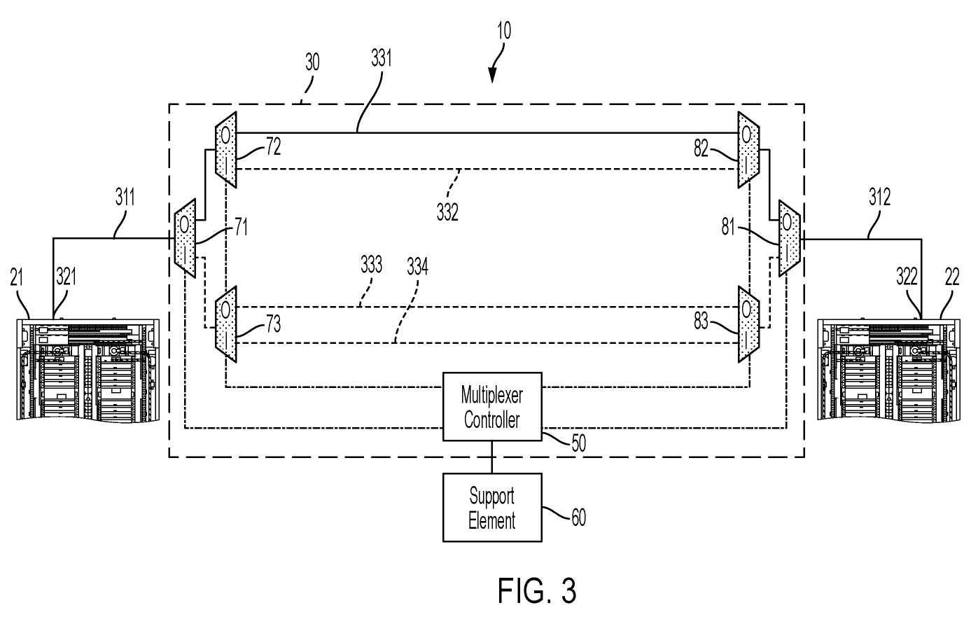

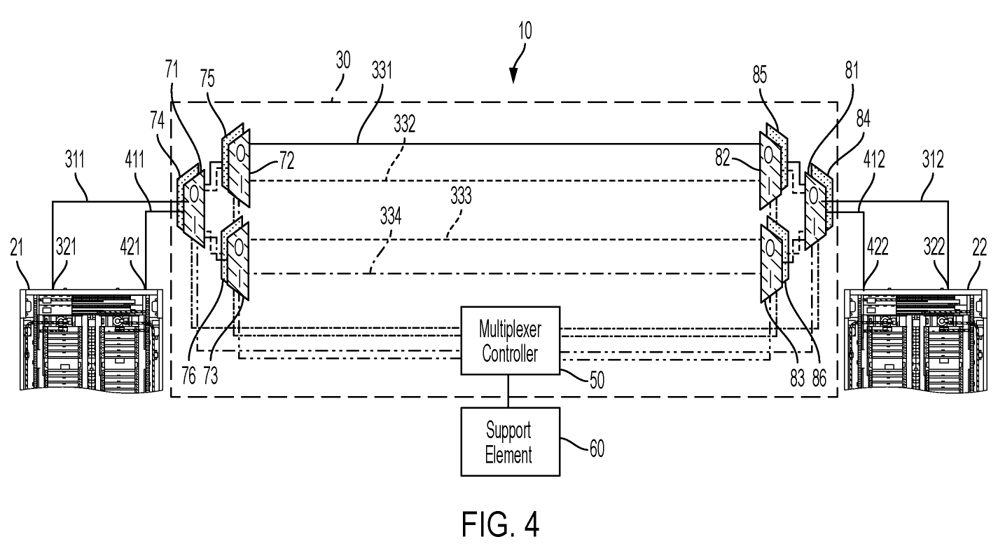

In one embodiment, the apparatus 10 further comprises a multiplexer controller 50 and a support element 60 which are not depicted in FIG. 1 but are depicted in FIGS. 3 and 4 described infra.

The multiple mainframes comprise a mainframe 21, a mainframe 22, a mainframe 23, and a mainframe 24. Generally, the multiple mainframes comprise two or more mainframes. The mainframe 22 includes a space 25 in which no hardware exists.

The bus bar 30 spans across the multiple mainframes 20 and is connected to one or more ports on each mainframe. Any mainframe of the multiple mainframes can be connected to any other mainframe of the multiple mainframes via the bus bar 30. Thus, there is no need for a cable to connect any mainframe of the multiple mainframes to any other mainframe of the multiple mainframes. In one embodiment, no cable connects any mainframe of the multiple mainframes to any other mainframe of the multiple mainframes. By definition, a first mainframe and a second mainframe are interconnected by a cable if the cable extends from a port of the first mainframe to as port of the second mainframe.

The bus bar 30 comprises multiple planar boards 31, 32, 33, and 34 stacked parallel to each other with a surface of each planar board being in direct mechanical contact with a surface of one or two other planar boards. Generally, the multiple planar boards consist of two or more planar boards.

Each planar board is specific to only one type of signal by being configured to transport only the one type of signal. Each planer board is specific to a different type of signal. In one embodiment, planar boards 31, 32, 33, and 34 are specific to a high voltage power signal, a Symmetric Multiprocessing (SMP) signal, a Peripheral Component Interconnect Express (PCIE) signal, and an ethernet signal, respectively.

The mux-demux 40 comprises multiple multiplexers and multiple demultiplexers which are shown in more detail in FIGS. 3 and 4 discussed infra.

A multiplexer is a device that selects one of several input signals and forwards the selected input signal to a single output line.

A demultiplexer is a device that receives a signal from a single input line and forwards the signal to an output line selected from multiple output lines.

FIG. 1 depicts X, Y, and Z directions defining a cartesian coordinate system in which the X, Y, and Z directions are mutually orthogonal. The mainframes 21-24 are sequenced in the X direction, a longest dimension of each mainframe of mainframes 21-24 is oriented in the Y direction, and a surface of each planar board of the planar boards 31-34 is in a X-Z plane.

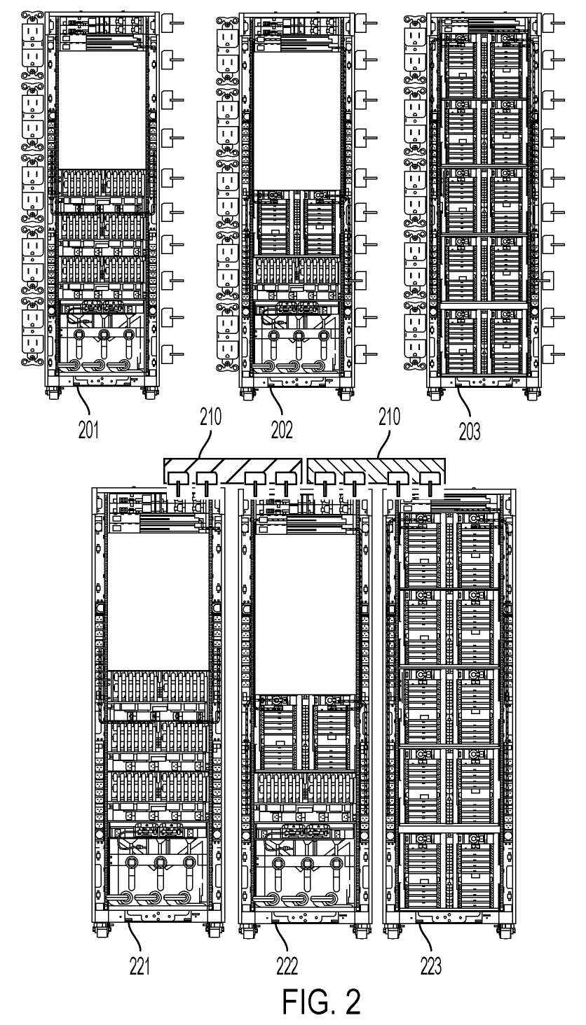

Although in FIG. 1 the bus bar 40 is one continuous bus bar oriented in the X direction and spans the top of mainframes 21-24 in FIG. 1, other possibilities exist as shown in FIG. 2.

FIG. 2 depicts alternative positioning of mainframes and a bus bar in an apparatus (e.g., the apparatus 10 of FIG. 1), in accordance with embodiments of the present invention.

In FIG. 2, mainframes 201, 202, and 203 are interconnected via adjacent frame plugging. In general, the bus bar can be placed on the frames including, inter alia, underneath the frames, on the back of the frames, in front of the frames, etc.

In addition, the bus bar need not be continuous. In one embodiment, for example, one continuous bus bar may be replaced by a daisy chain of bus bars as illustrated by the daisy chain 210 of bus bars spanning mainframes 221, 222, and 223.

FIG. 3 depicts the apparatus 10 of FIG. 1 in greater detail, in accordance with embodiments of the present invention.

The bus bar 30 is depicted in FIG. 3 as a circuit diagram that includes: a multiplexer controller 50, multiple demultiplexers, multiple multiplexers, and multiple bus wires. The multiple demultiplexers comprise demultiplexers 71, 72, and 73. The multiple multiplexers comprise multiplexers 81, 82, and 83. The multiple bus wires comprise bus wires 331, 332, 333, and 334.

The demultiplexer 71 is electrically connected to the demultiplexers 72 and 73 and is electrically connected to the mainframe 21 at port 321 via jumper cable 311 (e.g., an ethernet jumper cable).

The multiplexer 81 is electrically connected to the multiplexers 82 and 83 and is electrically connected to the mainframe 22 at port 322 via jumper cable 312 (e.g., an ethernet jumper cable).

Thus, the multiple demultiplexers 71-73 within the bus bar 30 are electrically connected to the port 321, and the multiple multiplexers 81-83 within the bus bar 30 are electrically connected to the port 322

Bus wires 331 and 332 each electrically connect the multiple demultiplexers to the multiple multiplexers by electrically connecting the multiplexer 72 to the multiplexer 82. Bus wires 331 and 332 are alternatives to replace each other if one bus wire of bus wires 331 and 332 fails or otherwise becomes unavailable for being used.

Bus wires 333 and 334 each electrically connect the multiple demultiplexers to the multiple multiplexers by electrically connecting the multiplexer 73 to the multiplexer 83. Bus wires 333 and 334 are alternatives to replace each other if one bus wire of bus wires 333 and 334 fails or otherwise becomes unavailable for being used.

Bus wires 331 and 332 are in a first planar board of planar boards 31-34, and bus wires 333 and 334 are in a second planar board of planar boards 31-34. In one embodiment, the first planar board and the second planer board are a same planer board. In one embodiment, the first planar board and the second planer board are different planer boards.

The multiplexer controller 50 is electrically connected to the demultiplexer 71, the demultiplexer 73, the multiplexer 81, and the multiplexer 83. In one embodiment, the multiplexer controller 50 is within the bus bar 30 as shown. In one embodiment, the multiplexer controller 50 external the bus bar 30 and is nonetheless electrically connected to the demultiplexer 71, the demultiplexer 73, the multiplexer 81, and the multiplexer 83.

The multiplexer controller 50 comprises a microprocessor configured to determine how and where to route signals and the multiplexer controller 50 is configured to route signals to desired destinations. The multiplexer controller 50 is hardware or software.

In addition, the multiplexer controller 50: allows dynamic signal connections for improved security, reliability, and test procedures; improves cable organization and simplifies cabling operations; allows return signal emulation for testing with limited hardware; and supports real time encryption/decryption on entry/exit from the bus bar 30.

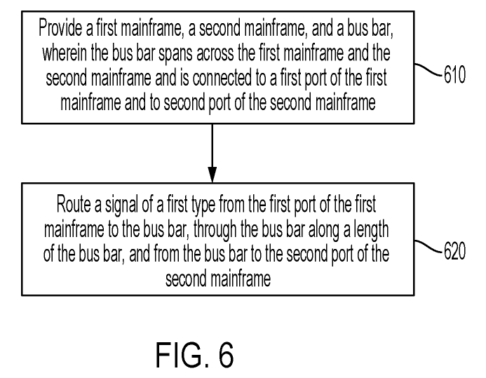

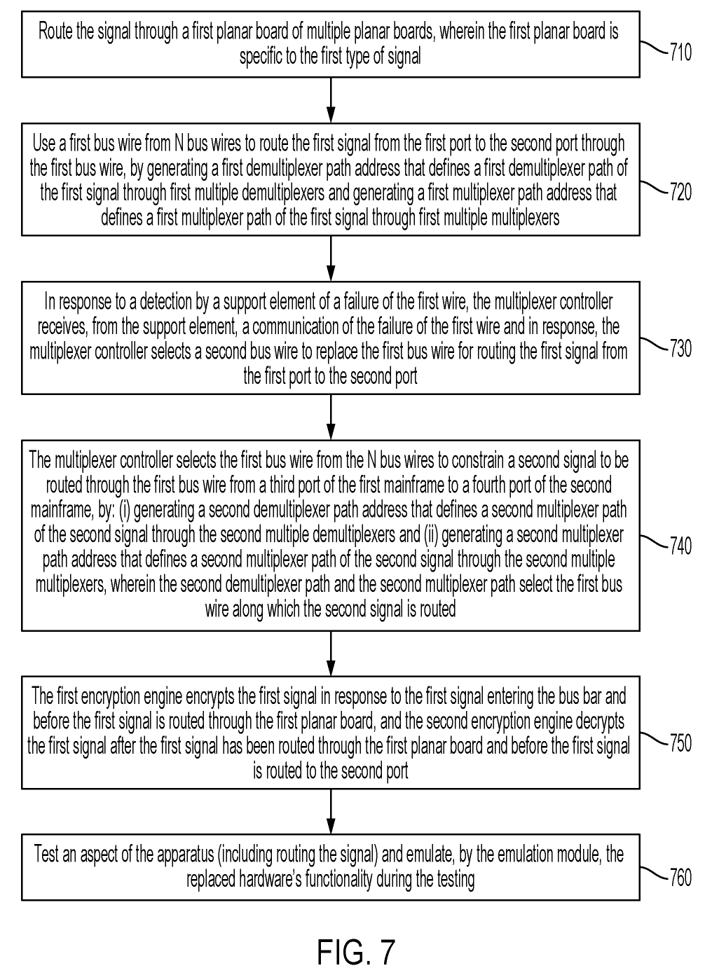

The support element 60, which is a computing device (e.g., a laptop), is communicatively connected to the multiplexer controller 50. In one embodiment, the support element 60 may be configured in accordance with the computer system 90 of FIG. 6 or the computing environment 100 of FIG. 7.

The support element 60 continuously, periodically, or sporadically monitors, and provides to the multiplexer controller 50, the current configuration of hardware components within the apparatus 10 (e.g., monitoring the health of the bus wires 331-334) and notifies the multiplexer controller 50 of failure of any hardware component within the apparatus 10.

For example, if the support element 60 notifies the multiplexer controller 50 of failure of bus wire 331, and if a signal from the mainframe 21 needs to be routed to mainframe 22 via bus wire 331 or 332, the multiplexer controller 50 will route the signal via bus wire 332 since bus wire 331 has failed and is thus currently unavailable for being used.

As another example, in response to a detection by the support element 60 of a failure of the bus wire 331, the support element 60 communicates the failure of the bus wire 331 to the multiplexer controller 50 for triggering the multiplexer controller 50 to select the bus wire 332 to replace the bus wire 331 for routing a signal from the port 321 of the mainframe 21 to the port 322 of the mainframe 22.

In one embodiment, the following addressing scheme may be used for selecting a bus wire of the bus wires 331-334 to route a signal from mainframe 21 to mainframe 22.

Each demultiplexer of demultiplexers 71-73 has a binary address of 0 or 1 as shown, and each multiplexer of multiplexers 81-83 has a binary address of 0 or1 as shown.

Demultiplexer 71 at address 0 is electrically connected to demultiplexer 72.

Demultiplexer 71 at address 1 is electrically connected to demultiplexer 73.

Multiplexer 81 at address 0 is electrically connected to multiplexer 82.

Multiplexer 81 at address 1 is electrically connected to multiplexer 83.

Bus wire 331 electrically interconnects demultiplexer 72 at address 0 with multiplexer 82 at address 0.

Bus wire 332 electrically interconnects demultiplexer72 at address 1 with multiplexer 82 at address 1.

Bus wire 333 electrically interconnects demultiplexer73 at address 0 with multiplexer 83 at address 0.

Bus wire 334 electrically interconnects demultiplexer73 at address 1 with multiplexer 83 at address 1.

A bus wire may be selected from bus wires 331-334 in accordance with a demultiplexer path address and a multiplexer path address.

For selection of bus wire 331, (i) the demultiplexer path address (00) is: the address (0) in demultiplexer 72 at which bus wire 331 is electrically connected, followed by the address (0) in demultiplexer 71 to which demultiplexer 72 is electrically connected and (ii) the multiplexer path address (00) is the address (0) in multiplexer 82 at which bus wire 331 is electrically connected followed by the address (0) in multiplexer 81 to which multiplexer 82 is electrically connected.

For selection of bus wire 332, (i) the demultiplexer path address (10) is: the address (1) in demultiplexer 72 at which bus wire 332 is electrically connected followed by the address (0) in demultiplexer 71 to which demultiplexer 72 is electrically connected and (ii) the multiplexer path address (10) is the address (1) in multiplexer 82 at which bus wire 332 is electrically connected, followed by the address (0) in multiplexer 81 to which multiplexer 82 is electrically connected.

For selection of bus wire 333, (i) the demultiplexer path address (01) is: the address (0) in demultiplexer 73 at which bus wire 333 is electrically connected, followed by the address (1) in demultiplexer 71 to which demultiplexer 73 is electrically connected and (ii) the multiplexer path address (01) is the address (0) in multiplexer 83 at which bus wire 333 is electrically connected, followed by the address (1) in multiplexer 81 to which multiplexer 83 is electrically connected.

For selection of bus wire 334, (i) the demultiplexer path address (11) is: the address (1) in demultiplexer 73 at which bus wire 334 is electrically connected, followed by the address (1) in demultiplexer 71 to which demultiplexer 73 is electrically connected and (ii) the multiplexer path address (11) is the address (1) in multiplexer 83 at which bus wire 334 is electrically connected, followed by the address (1) in multiplexer 81 to which multiplexer 83 is electrically connected.

Note that the preceding demultiplexer path addresses and multiplexer path addresses (00, 10, 01, 11) are each sequenced starting with the address in the demultiplexer/multiplexer that is furthest from a mainframe and moves sequentially to the address in the demultiplexer/multiplexer that is nearest to the mainframe. For example, the demultiplexer path address of 10 starts with address (1) in the demultiplexer 72 that is furthest from the mainframe 21 and moves sequentially to the address (0) in the demultiplexer 71 that is nearest to the mainframe 21.

In one embodiment, the multiplexer controller 50 is configured to sequentially route a first signal of a first type of signal: from the first port 321 in the mainframe 21, through a first bus wire in a first planar board of the bus bar 30, and to a first port 322 in the mainframe 22. The first planar board is specific to the first type of signal. The multiplexer controller 50 comprises a microprocessor configured to determine how and where to route the first signal, based on the bus wire selected by a demultiplexer path address and a multiplexer path address.

More specifically in the preceding one embodiment, the multiplexer controller 50 is configured to use a first bus wire selected from the bus wires (331-334) to route the first signal from the first port (321) to the second port (322) through the first bus wire, by being configured to generate a first demultiplexer path address that defines a first demultiplexer path of the first signal through first multiple demultiplexers and to generate a first multiplexer path address that defines a first multiplexer path of the first signal through the first multiple multiplexers such that the first demultiplexer path and the first multiplexer path select the first bus wire along which the first signal is routed.

As an example with the first bus wire being bus wire 332, the multiplexer controller 50 is configured to: (i) generate a first demultiplexer path address (10) that defines a first demultiplexer path of the first signal through the first multiple demultiplexers 71 and 72 and (ii) generate a first multiplexer path address (10) that defines a first multiplexer path of the first signal through the first multiple multiplexers 82 and 81. The first demultiplexer path address (10) and the first multiplexer path address (10) select the first multiplexer path including the first bus wire 332 along which the first signal is routed.

FIG. 4 depicts a modification of the apparatus 10 of FIG. 3, in accordance with embodiments of the present invention.

The modification includes the multiple demultiplexers comprising (i) demultiplexers 74-76 in addition to demultiplexers 71-73, respectively and (ii) multiplexers 84-86 in addition to multiplexers 81-83, respectively.

The demultiplexers 74-76 each have addresses 0 and 1 (not shown in FIG. 4) positioned similar to the addresses 0 and 1 in the demultiplexers 71-73.

The multiplexers 84-86 each have addresses 0 and 1 (not shown in FIG. 4) positioned similar to the addresses 0 and 1 in the multiplexers 81-83.

The demultiplexer 74 is electrically connected to demultiplexers 75 and 76 in a same manner as the demultiplexer 71 is electrically connected to demultiplexers 72 and 73 (i.e., the demultiplexer 74 is electrically connected to the demultiplexers 75 and 76 and is electrically connected to the mainframe 21 at port 421 via jumper cable 411).

The multiplexer 84 is electrically connected to multiplexers 85 and 86 in a same manner as the multiplexer 81 is electrically connected to multiplexers 82 and 83 (i.e., multiplexer 84 is electrically connected to the multiplexers 85 and 86 and is electrically connected to the mainframe 22 at port 422 via jumper cable 412).

The demultiplexers 72 and 75, and the multiplexers 82 and 85, use the same bus wires 331 and 332.

The demultiplexers 73 and 76, and the multiplexers 83 and 86, use the same bus wires 333 and 334.

In one embodiment, demultiplexers 71-73 and 74-76 are source connection multiplexers of a signal routed from mainframe 22, and multiplexers 81-83 and 84-86 are sink connection multiplexers of the signal routed to the mainframe 23.

Thus, the same set of bus wires may be used rather than having multiple spare wires per source/sink connection. Since each source and sink connection multiplexer has an associated demultiplexer path address and multiplexer path address, and only one electrical connection is made at a time per demultiplexer/multiplexer (i.e., unselected electrical connections will be floating/disconnected), multiple demultiplexers and multiple multiplexers are connected to each bus wire which will allow each source and sink pairing to use whatever bus wire the system configuration needs. For example, different wire designs might be used if certain protocols require greater signal integrity, or larger electromigration/current-resistance (IR) voltage drop limits, etc.

A bus wire may be selected from bus wires 331-334 by a demultiplexer path address associated with demultiplexers 71-73 and a multiplexer path address associated with multiplexers 81-83 as discussed supra in conjunction with FIG. 3.

The bus wire of bus wires 331-334 may alternatively be selected by a demultiplexer path address associated with demultiplexers 74-76 and a multiplexer path address associated with demultiplexers 84-86 in the following manner.

For selection of bus wire 331, (i) the demultiplexer path address (00) is: the address (0) in demultiplexer 75 at which bus wire 331 is electrically connected followed by the address (0) in demultiplexer 74 to which demultiplexer 75 is electrically connected and (ii) the multiplexer path address (00) is the address (0) in multiplexer 85 at which bus wire 331 is electrically connected followed by the address (0) in multiplexer 84 to which multiplexer 85 is electrically connected

For selection of bus wire 332, (i) the demultiplexer path address (10) is: the address (1) in demultiplexer 75 at which bus wire 332 is electrically connected followed by the address (0) in demultiplexer 74 to which demultiplexer 75 is electrically connected and (ii) the multiplexer path address (10) is the address (1) in multiplexer 85 at which bus wire 332 is electrically connected followed by the address (0) in multiplexer 84 to which multiplexer 85 is electrically connected.

For selection of bus wire 333, (i) the demultiplexer path address (01) is: the address (0) in demultiplexer 76 at which bus wire 333 is electrically connected followed by the address (1) in demultiplexer 74 to which demultiplexer 76 is electrically connected and (ii) the multiplexer path address (01) is the address (0) in multiplexer 86 at which bus wire 333 is electrically connected followed by the address (1) in multiplexer 84 to which multiplexer 86 is electrically connected.

For selection of bus wire 334, (i) the demultiplexer path address (11) is: the address (1) in demultiplexer 76 at which bus wire 334 is electrically connected followed by the address (1) in demultiplexer 74 to which demultiplexer 76 is electrically connected and (ii) the multiplexer path address (11) is the address (1) in multiplexer 86 at which bus wire 334 is electrically connected followed by the address (1) in multiplexer 84 to which multiplexer 86 is electrically connected.

In one embodiment (discussed supra in conjunction with FIG. 3), the multiplexer controller 50 is configured to sequentially route a first signal of a first type of signal: from the first port 321 in the mainframe 21, through a first bus wire in a first planar board of the bus bar 30, and to a first port 322 in the mainframe 22. The first planar board is specific to the first type of signal. The multiplexer controller 50 comprises a microprocessor configured to determine how and where to route the first signal, based on the bus wire selected by a demultiplexer path address and a multiplexer path address.

More specifically in the preceding one embodiment, the multiplexer controller 50 is configured to use a first bus wire selected from the bus wires (331-334) to route the first signal from the first port (321) to the second port (322) through the first bus wire, by being configured to generate a first demultiplexer path address that defines a first demultiplexer path of the first signal through first multiple demultiplexers and to generate a first multiplexer path address that defines a first multiplexer path of the first signal through the first multiple multiplexers such that the first demultiplexer path and the first multiplexer path select the first bus wire along which the first signal is routed.

As an example with the first bus wire being bus wire 332, the multiplexer controller 50 is configured to generate a first demultiplexer path address (10) that defines a first demultiplexer path of the first signal through the first multiple demultiplexers 71 and 72 and to generate a first multiplexer path address (10) that defines a first multiplexer path of the first signal through the first multiple multiplexers 82 and 81 such that the first demultiplexer path and the first demultiplexer path select the first bus wire 332 along which the first signal is routed.

The preceding one embodiment is next expanded as follows in accordance with FIG. 4.

The multiplexer controller 50 is configured to sequentially route a second signal of the first type of signal: from a third port 421 in the mainframe 21, through the first bus wire in the first planar board of the bus bar 30, and to a fourth port 422 in the mainframe 22. The first planar board is specific to the first type of signal. The multiplexer controller 50 comprises a microprocessor configured to determine how and where to route the first signal, based on the bus wire selected by a demultiplexer path address and a multiplexer path address.

More specifically in the preceding expanded one embodiment, the multiplexer controller 50 is configured to use the first bus wire to route the second signal from the third port 421 to the fourth port 422 through the first bus wire, by being configured to generate a second demultiplexer path address that defines a second demultiplexer path of the second signal through second multiple demultiplexers and to generate a second multiplexer path address that defines a second multiplexer path of the second signal through the second multiple multiplexers such that the second demultiplexer path and the second multiplexer path select the first bus wire along which the second signal is routed.

As an example with the first bus wire being bus wire 332, the multiplexer controller 50 is configured to generate a second demultiplexer path address (10) that defines a second demultiplexer path of the second signal through the second multiple demultiplexers 74 and 75 and to generate a second multiplexer path address (10) that defines a second multiplexer path of the second signal through the second multiple multiplexers 85 and 84 such that the first demultiplexer path which the second signal is routed.

Although the demultiplexers and multiplexers in FIGS. 3 and 4 are configured to enable an even number of bus wires, the demultiplexers and multiplexers could be alternatively configured to enable an odd number of bus wires. Thus, the bus bar 30 generally comprises one or more bus wires.

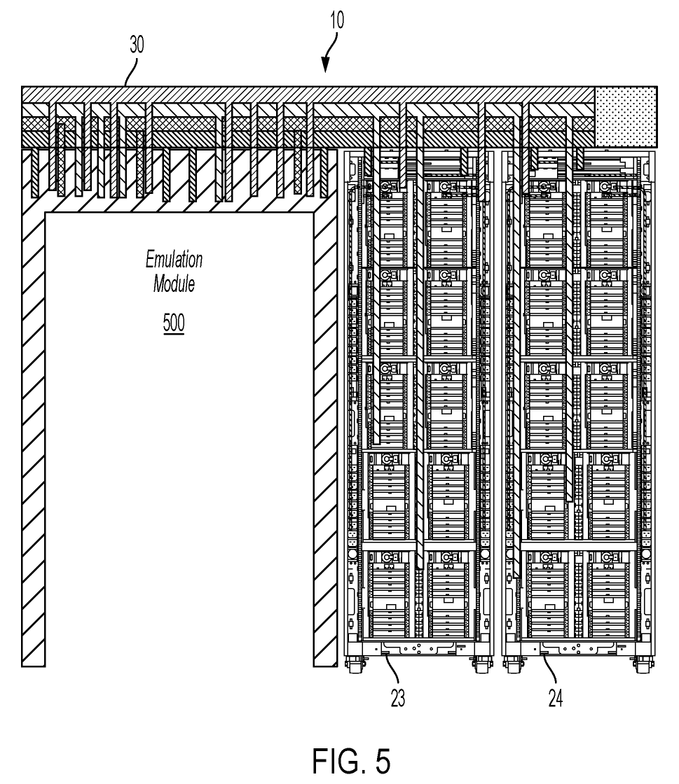

FIG. 5 depicts the apparatus 10 of FIG. 1 after the hardware in mainframes 21 and 22 have been replaced by an emulation module 500, in accordance with embodiments of the present invention. The emulation module 500 emulates the replaced hardware’s functionality during a test of the apparatus 10.

The emulation module 500 may be hardware or software.

Generally, the emulation module 500 replaces hardware in one or more mainframes in the multiple mainframes. In one embodiment, an emulation module in the mainframe 22 replaces hardware in the mainframe 22 to emulate the replaced hardware’s functionality configured to process the first signal during a test of an aspect of the apparatus 10.

FIG. 6 is a flow chart describing a method for using an apparatus, in accordance with embodiments of the present invention. The method of FIG. 6 includes steps 610 and 620.

Step 610 provides a first mainframe, a second mainframe, and a bus bar, wherein the bus bar spans across the first mainframe and the second mainframe and is connected to a first port of the first mainframe and to second port of a second mainframe

Step 620 routes a signal of a first type from the first port of the first mainframe to the bus bar, through the bus bar along a length of the bus bar, and from the bus bar to the second port of the second mainframe.

FIG. 7 is a flow chart describing a process relating to implementation of step 620 of FIG. 6 which routes a signal from the first port of the first mainframe to the second port of the second mainframe, in accordance with embodiments of the present invention. The method of FIG. 6 includes steps 710 -760.

The bus bar comprises multiple planar boards stacked parallel to each other with a surface of each planar board being in direct mechanical contact with a surface of one or two other planar boards. Each planar board is specific to only one type of signal by being configured to transport only the one type of signal, wherein each planar board is specific to a different type of signal.

Step 710 routes the signal through a first planar board of the multiple planar boards, wherein the first planar board is specific to the first type of signal.

The apparatus comprises: first multiple demultiplexers within the bus bar and electrically connected to the first port; first multiple multiplexers within the bus bar and electrically connected to the second port, wherein the first planar board comprises N bus wires, wherein N is a positive integer, and wherein each bus wire electrically connects the first multiple demultiplexers to the first multiple multiplexers.

Step 720 uses a first bus wire from the N bus wires to route the first signal from the first port to the second port through the first bus wire, by generating a first demultiplexer path address that defines a first demultiplexer path of the first signal through first multiple demultiplexers and generating a first multiplexer path address that defines a first multiplexer path of the first signal through first multiple multiplexers.

The bus bar comprises a multiplexer controller that performs the routing in step 720, wherein the apparatus further comprises a support element which is a computing device communicatively connected to the multiplexer controller and configured to monitor the health of the N bus wires.

In step 730, in response to a detection by the support element of a failure of the first wire, the multiplexer controller receives, from the support element, a communication of the failure of the first wire and in response, the multiplexer controller selects a second bus wire to replace the first bus wire for routing the first signal from the first port to the second port.

Second multiple demultiplexers are within the bus bar and are electrically connected to a third port of the first mainframe, wherein second multiple multiplexers are within the bus bar and are electrically connected to a fourth port of the second mainframe, wherein each bus wire electrically connects the first multiple demultiplexers to the first multiple multiplexers and electrically connects the second multiple demultiplexers to the second multiple multiplexers.

In step 740, the multiplexer controller selects the first bus wire from the N bus wires to constrain a second signal to be routed through the first bus wire from the third port of the first mainframe to the fourth port of the second mainframe, by: (i) generating a second demultiplexer path address that defines a second multiplexer path of the second signal through the second multiple demultiplexers and (ii) generating a second multiplexer path address that defines a second multiplexer path of the second signal through the second multiple multiplexers, wherein the second demultiplexer path and the second multiplexer path select the first bus wire along which the second signal is routed.

The bus bar comprises a first encryption engine and a second encryption engine.

In step 750, the first encryption engine encrypts the first signal in response to the first signal entering the bus bar and before the first signal is routed through the first planar board, and the second encryption engine decrypts the first signal after the first signal has been routed through the first planar board and before the first signal is routed to the second port.

The second mainframe comprises an emulation module that that replaces hardware in the second mainframe.

In step 760, an aspect of the apparatus is tested, which includes routing the signal, and

the emulation module emulates the replaced hardware’s functionality during the testing.

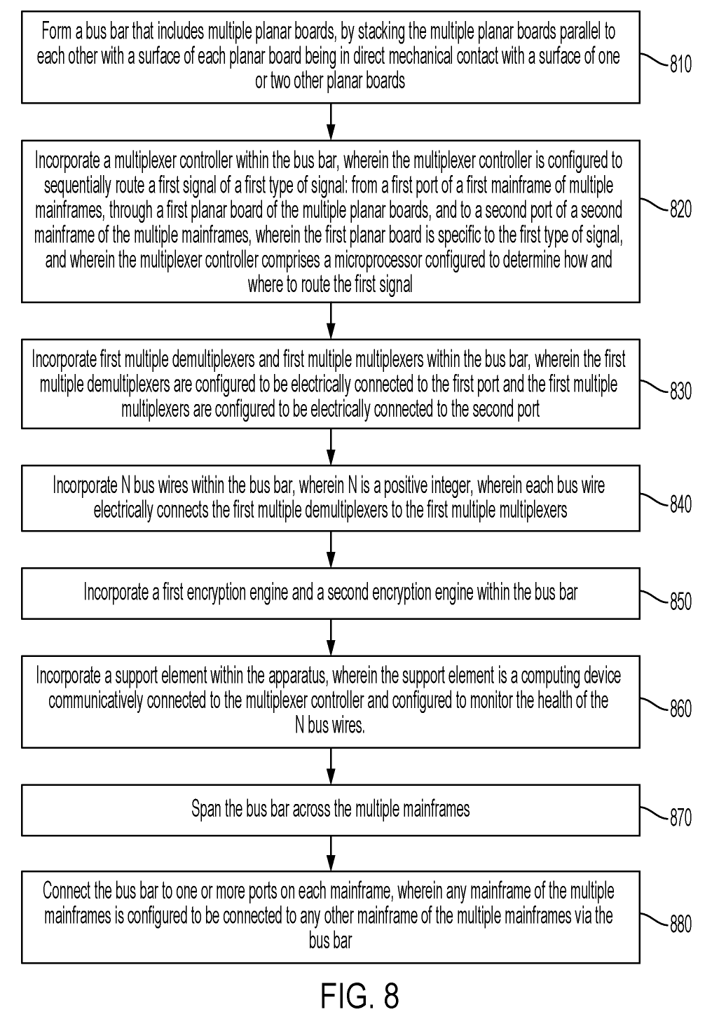

FIG. 8 is a flow chart for describing a method for forming an apparatus that includes multiple mainframes and a bus bar, in accordance with embodiments of the present invention. The flow chart of FIG. 8 includes steps 810-880.

Step 810 forms the bus bar that includes multiple planar boards, by stacking the multiple planar boards parallel to each other with a surface of each planar board being in direct mechanical contact with a surface of one or two other planar boards. Each planar board is specific to only one type of signal by being configured to transport only the one type of signal, wherein each planar board is specific to a different type of signal.

Step 820 incorporates a multiplexer controller within the bus bar, wherein the multiplexer controller is configured to sequentially route a first signal of a first type of signal: from a first port of a first mainframe of the multiple mainframes, through a first planar board of the multiple planar boards, and to a second port of a second mainframe of the multiple mainframes, wherein the first planar board is specific to the first type of signal, and wherein the multiplexer controller comprises a microprocessor configured to determine how and where to route the first signal.

Step 830 incorporates first multiple demultiplexers and first multiple multiplexers within the bus bar, wherein the first multiple demultiplexers are configured to be electrically connected to the first port and the first multiple multiplexers are configured to be electrically connected to the second port.

Step 840 incorporates N bus wires within the bus bar, wherein N is a positive integer, and wherein each bus wire electrically connects the first multiple demultiplexers to the first multiple multiplexers.

The multiplexer controller is configured to use a first bus wire from the N bus wires to route the first signal from the first port to the second port through the first bus wire, by being configured to generate a first demultiplexer path address that defines a first demultiplexer path of the first signal through the first multiple demultiplexers and to generate a first multiplexer path address that defines a first multiplexer path of the first signal through the first multiple multiplexers, wherein the first demultiplexer path and the first multiplexer path select the first bus wire along which the first signal is routed.

Step 850 incorporates a first encryption engine and a second encryption engine within the bus bar. The first encryption engine is configured to encrypt the first signal in response to the first signal entering the bus bar and before the first signal is routed through the first planar board. The second encryption engine is configured to decrypt the first signal after the first signal has been routed through the first planar board and before the first signal is routed to the second port.

Step 860 incorporates a support element within the apparatus. The support element is a computing device communicatively connected to the multiplexer controller and configured to monitor the health of the N bus wires.

Step 870 spans the bus bar across the multiple mainframes.

Step 880 connects the bus bar to one or more ports on each mainframe, wherein any mainframe of the multiple mainframes is configured to be connected to any other mainframe of the multiple mainframes via the bus bar.

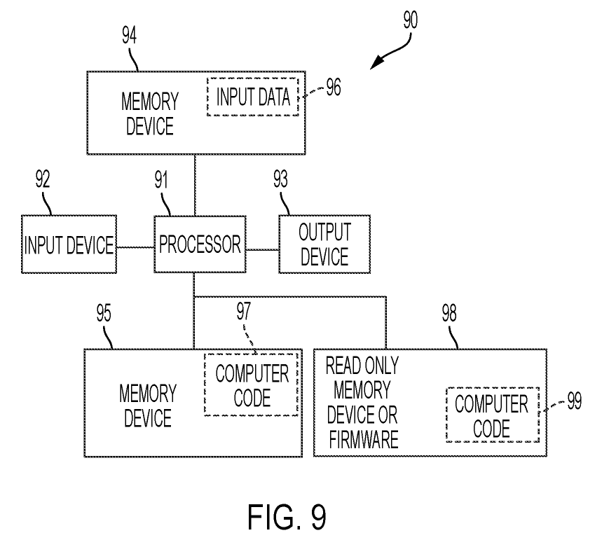

FIG. 9 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

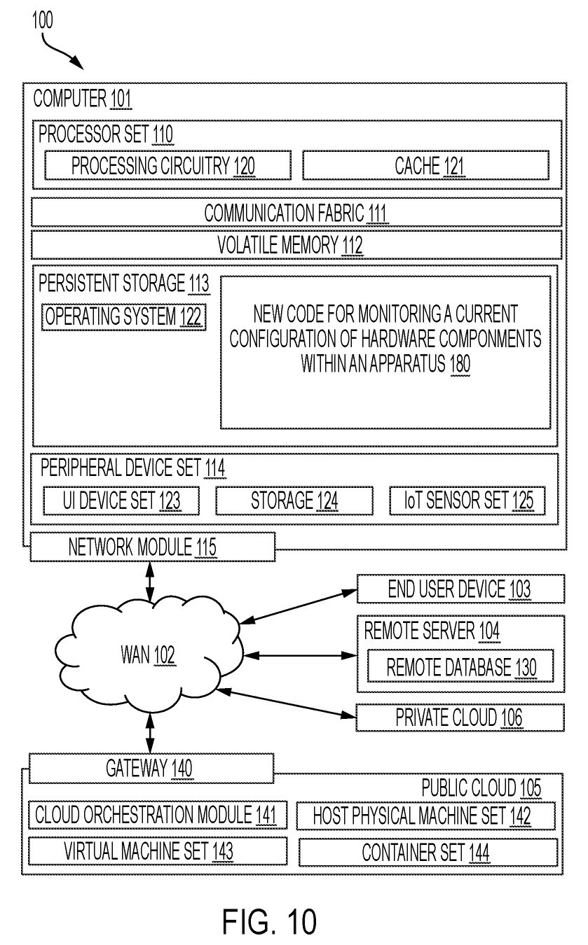

FIG. 10 depicts a computing environment 100 which contains an example of an environment for the execution of at least some of the computer code involved in performing the inventive methods, in accordance with embodiments of the present invention. Such computer code includes new code for monitoring a current configuration of hardware components within an apparatus 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 10. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 10): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus, comprising:
multiple mainframes; and
a bus bar spanning across the multiple mainframes and connected to one or more ports on each mainframe, wherein any mainframe of the multiple mainframes is configured to be connected to any other mainframe of the multiple mainframes via the bus bar.

2. The apparatus of claim 1, wherein the bus bar comprises multiple planar boards stacked parallel to each other with a surface of each planar board being in direct mechanical contact with a surface of one or two other planar boards, wherein each planar board is specific to only one type of signal by being configured to transport only the one type of signal, and wherein each planar board is specific to a different type of signal .

3. The apparatus of claim 2, further comprising:
a multiplexer controller within, or external to, the bus bar and configured to sequentially route a first signal of a first type of signal: from a first port of a first mainframe of the multiple mainframes, through a first planar board of the multiple planar boards, and to a second port of a second mainframe of the multiple mainframes, wherein the first planar board is specific to the first type of signal, and wherein the multiplexer controller comprises a microprocessor configured to determine how and where to route the first signal.

4. The apparatus of claim 3, further comprising:
first multiple demultiplexers within the bus bar and electrically connected to the first port;
first multiple multiplexers within the bus bar and electrically connected to the second port,
wherein the first planar board comprises N bus wires, N being a positive integer,
wherein each bus wire electrically connects the first multiple demultiplexers to the first multiple multiplexers,
wherein the multiplexer controller is configured to use a first bus wire from the N bus wires to route the first signal from the first port to the second port through the first bus wire, by being configured to generate a first demultiplexer path address that defines a first demultiplexer path of the first signal through the first multiple demultiplexers and to generate a first multiplexer path address that defines a first multiplexer path of the first signal through the first multiple multiplexers, wherein the first demultiplexer path and the first multiplexer path select the first bus wire along which the first signal is routed.

5. The apparatus of claim 4, further comprising:
a support element, which is a computing device, communicatively connected to the multiplexer controller and configured to monitor the health of the N bus wires,
wherein in response to a detection by the support element of a failure of the first wire, the support element is configured communicate the failure of the first wire to the multiplexer controller for triggering the multiplexer controller to select a second bus wire to replace the first bus wire for routing the first signal from the first port to the second port.

6. The apparatus of claim 4, further comprising:
second multiple demultiplexers within the bus bar and electrically connected to a third port of the first mainframe;
second multiple multiplexers within the bus bar and electrically connected to a fourth port of the second mainframe,
wherein each bus wire electrically connects the first multiple demultiplexers to the first multiple multiplexers and electrically connects the second multiple demultiplexers to the second multiple multiplexers ,
wherein the multiplexer controller is configured to select the first bus wire from the N bus wires to constrain a second signal to be routed from the third port to the fourth port through the first bus wire, by being configured to generate a second demultiplexer path address that defines a second multiplexer path of the second signal through the second multiple demultiplexers and to generate a second multiplexer path address that defines a second multiplexer path of the second signal through the second multiple multiplexers, wherein the second demultiplexer path and the second multiplexer path select the first bus wire along which the second signal is routed.

7. The apparatus of claim 3, wherein the multiplexer controller is within the bus bar.

8. The apparatus of claim 3, further comprising:
a first encryption engine in the bus bar and configured to encrypt the first signal in response to the first signal entering the bus bar and before the first signal is routed through the first planar board; and
a second encryption engine in the bus bar and configured to decrypt the first signal after the first signal has been routed through the first planar board and before the first signal is routed to the second port.

9. The apparatus of claim 1, further comprising:
an emulation module in the second mainframe that replaces hardware in the second mainframe to emulate the replaced hardware’s during a test of an aspect of the apparatus.

10. The apparatus of claim 1, wherein X, Y, and Z directions define a cartesian coordinate system in which the X, Y, and Z directions are mutually orthogonal, wherein the mainframes are sequenced in the X direction, a longest dimension of each mainframe is oriented in the Y direction, and a surface of each planar board is in a X-Z plane.

11. The apparatus of claim 1, wherein there are no cables interconnecting mainframes of the multiple mainframes.

12. A method for using an apparatus, said method comprising:
routing a signal of a first type from a first port of a first mainframe to a bus bar, through the bus bar along a length of the bus bar, and from the bus bar to a second port of a second mainframe, wherein the bus bar spans across the first mainframe and the second mainframe and is connected to the first port and the second port.

13. The method of claim 12, wherein the bus bar comprises multiple planar boards stacked parallel to each other with a surface of each planar board being in direct mechanical contact with a surface of one or two other planar boards, wherein each planar board is specific to only one type of signal by being configured to transport only the one type of signal, wherein each planar board is specific to a different type of signal, and wherein said routing comprises:
routing the signal through a first planar board of the multiple planar boards, wherein the first planar board is specific to the first type of signal.

14. The method of claim 13, wherein the apparatus comprises: first multiple demultiplexers within the bus bar and electrically connected to the first port; first multiple multiplexers within the bus bar and electrically connected to the second port, wherein the first planar board comprises N bus wires, wherein N is a positive integer, wherein each bus wire electrically connects the first multiple demultiplexers to the first multiple multiplexers, and wherein said routing comprises:
using a first bus wire from the N bus wires to route the first signal from the first port to the second port through the first bus wire, by generating a first demultiplexer path address that defines a first demultiplexer path of the first signal through first multiple demultiplexers and generating a first multiplexer path address that defines a first multiplexer path of the first signal through first multiple multiplexers.

15. The method of claim 14, wherein the bus bar comprises a multiplexer controller that performs said routing, wherein the apparatus further comprises a support element, which is a computing device, communicatively connected to the multiplexer controller and configured to monitor the health of the N bus wires, and wherein the method comprises:
in response to a detection by the support element of a failure of the first wire, receiving, by the multiplexer controller from the support element, a communication of the failure of the first wire; and
in response to said receiving the communication, said multiplexer controller selecting a second bus wire to replace the first bus wire for routing the first signal from the first port to the second port.

16. The method of claim 14, wherein second multiple demultiplexers are within the bus bar and are electrically connected to a third port of the first mainframe, wherein second multiple multiplexers are within the bus bar and are electrically connected to a fourth port of the second mainframe, wherein each bus wire electrically connects the first multiple demultiplexers to the first multiple multiplexers and electrically connects the second multiple demultiplexers to the second multiple multiplexers, and wherein the method comprises:
selecting, by the multiplexer controller, the first bus wire from the N bus wires to constrain a second signal to be routed from the third port to the fourth port through the first bus wire by: generating a second demultiplexer path address that defines a second multiplexer path of the second signal through the second multiple demultiplexers and generating a second multiplexer path address that defines a second multiplexer path of the second signal through the second multiple multiplexers, wherein the second demultiplexer path and the second multiplexer path select the first bus wire along which the second signal is routed.

17. The method of claim 13, wherein the bus bar comprises a first encryption engine and a second encryption engine, and wherein the method comprises:
encrypting, by the first encryption engine, the first signal in response to the first signal entering the bus bar and before the first signal is routed through the first planar board; and
decrypting, by the second encryption engine, the first signal after the first signal has been routed through the first planar board and before the first signal is routed to the second port.

18. The method of claim 12, wherein the second mainframe comprises an emulation module that that replaces hardware in the second mainframe, and wherein the method comprises:
testing an aspect of the apparatus, said testing comprising routing the signal; and
emulating, by the emulation module, the replaced hardware’s functionality during said testing.

19. A method for forming an apparatus, said method comprising:
spanning a bus bar across multiple mainframes; and
connecting the bus bar to one or more ports on each mainframe of the multiple mainframes, wherein any mainframe of the multiple mainframes is configured to be connected to any other mainframe of the multiple mainframes via the bus bar.

20. The method of claim 19, wherein the bus bar comprises multiple planar boards, wherein each planar board is specific to only one type of signal by being configured to transport only the one type of signal, wherein each planar board is specific to a different type of signal, and wherein the method comprises:
forming the bus bar by stacking the multiple planar boards parallel to each other with a surface of each planar board being in direct mechanical contact with a surface of one or two other planar boards.
